(19) United States
(12) Patent Application Publication
(10) Pub. No.: US 2017/0059275 A1
(43) Pub. Date: Mar. 2, 2017

(54) Safety Holster

(71) Applicant: Aaron Cohen, Beverly Hills, CA (US)

(72) Inventor: Aaron Cohen, Beverly Hills, CA (US)

(21) Appl. No.: 14/833,988

(22) Filed: Aug. 24, 2015

(51) Int. Cl. F41C 33/02; F41C 33/04; B26B 29/02

(52) U.S. Cl. CPC F41C 33/0227; B26B 29/025; F41C 33/041

(57) ABSTRACT

A safety holster has a retention section, a trigger guard section in communication with the retention section, a blade sheath secured to the retention section, and a belt clip attached to the blade sheath. The safety holster is formed by a single piece material and has an opening secured by a fastening device.

### FIELD OF THE INVENTION

The present invention generally relates safety holster, more specifically, safety holsters for plain clothed law enforcement, off duty law enforcement, and covert operations agents.

### BACKGROUND OF THE INVENTION

Carrying a concealed firearm is a necessity for an undercover law enforcement officer, off duty law enforcement and covert operations unit personnel. When carrying a firearm, the firearm must not be easily detected or visible to others, except in an emergency situation in which the law enforcement officer or undercover operative needs to be able to rapidly draw the firearm to protect himself, his teammates or innocent bystanders from active shooter or terrorist threats. Most deep concealment, rapid draw holsters currently available to law enforcement, off duty and undercover operatives are made from nylon and uses a cummerbund style belt to secure the firearm and have zero or no retention thus making the firearm nonusable and unsafe when deployed or responding to highly physical confrontations where violence of action and extreme use of force is necessary to thwart a lethal attacker.

Therefore, it is safer and easier to use firearm holster that enables plain clothes law enforcement, off duty and covert operations personnel to deeply conceal a firearm with a full safety retention system when not in use and also be able to rapidly draw the firearm in an emergency situation which is what the present invention is primarily designed for.

### SUMMARY OF THE INVENTION

The present invention has been made to provide safe operations to undercover law enforcement officers or special operation agents. A safety holster of the present invention comprises a retention section, a trigger guard section in communication with the retention section, a blade sheath secured to the retention section, and a belt clip attached to the blade sheath. The safety holster is formed by a single piece material and has an opening secured by a fastening device. The opening defines a width, which can be adjusted by the at least one fastening device. Alternatively, the safety holster is formed by a tube like material that defines a space for a hand gun and the space for hand gun can be adjusted by the fastening device. The belt clip has a top edge and the handle of the hand gun is below the top edge of the belt clip and the trigger guard section fully covers the trigger mechanism of the hand gun. A friction layer is attached to the belt clip to secure the position of the belt clip to the belt. Alternatively, a slot is defined on the belt clip and a fastening device is inserted through the slot to attach the belt clip to the retention section, the position of the belt clip relative to the retention section is adjusted by sliding the belt clip. The blade sheath is placed angularly away from the belt clip. The retention section may be formed by a thermoplasticacylic-polyvinyl chloride material or by metal such as aluminum.

In an alternative embodiment, it is disclosed a blade holder with a sheath, a belt clip attached to the sheath, and a friction layer attached to the belt clip, wherein the sheath is disposed angularly away from the belt clip. The sheath is disposed 35 degrees away from the belt clip and formed by a thermoplasticacylic-polyvinyl chloride material or by metal such as aluminum.

### BRIEF DESCRIPTION OF THE DRAWINGS

The present invention can be understood in more detail by reading the subsequent detailed description in conjunction with the examples and references made to the accompanying drawings, wherein:

FIG. 1 shows a safety holster according to one embodiment of the invention;

FIG. 2 illustrates the safety holster of the invention in use;

FIG. 3 illustrates an alternative embodiment of the present invention;

FIG. 4 illustrates a blade holder according to the present invention; and

FIG. 5 illustrates yet another alternative embodiment of the safety holder of the present invention.

### DETAILED DESCRIPTION OF THE PREFERRED EMBODIMENTS

The present invention provides a safety holster for undercover law enforcement officer. The safety holster enables an undercover agent to carry a revolver inside his pants without being visually detected.

Integrated onto the clip loop side of the holster is a custom molded full retention removable blade sheath that houses a last ditch blade. The blade can act as a secondary or back up weapon if the primary firearm is no longer usable due to malfunctions or lack of ammunition or as a rapid draw primary weapon if target neutralization must be done with stealth while deployed on a covert operation for counter terrorist warfare.

The sheath is mounted on top of the firearm holster allowing it to be secured by a single belt clip loop. The sheath is mounted canted, approximately 35 degrees clockwise, away from the firearm forcing the blade handle to sit level with the hammer allowing for an instinctive full gross-motor blade-grab with zero interference from the firearm or any part of the firearm holster system. The same goes for the firearm draw.

The blade sheath design and specific mounting of the sheath on the firearm holster system allows for a clean rapid firearm draw with a full proper retention grip on the firearm handle with zero interference from the blade or blade sheath

The holster according to the present invention is a true deep concealment holster in that it physically sits below the user's waistband (BWB). The custom design of the holster allows the user to carry below the waistband appendix style while drastically reducing the risk of accidental or negligent discharge. There are two specific unique design features that create this added retention: full enclosed trigger guard mold and high cut retention.

The full enclosed trigger guard mold fully encapsulates the trigger housing mechanism and actual trigger itself reducing risks of accidental discharge while the firearm is worn properly mounted in the actual holster.

The high cut retention forces deep firearm seating for extreme added retention. A full retention mold covers the upper portion of the firearm allowing the firearm to sit very deep into the holster. This reduces risk of slippage out of the holster system even when the user is inverted. This also greatly reduces risk of the firearm being pulled out by a third party aggressor. This retention is critical when deployed on dynamic, highly physical undercover counter terror operations. The deep seating of the weapon combined with the fitted mold combined with the below the waistband placement highly stabilizes the firearm while running, jumping, fighting and crawling.

The present invention presents two new features: a) the actual position of where the belt clip loop is mounted and b) the retention design of the actual belt clip loop itself. The holster is anchored below the waistband with high mounted loop clip design which forces the holster to sit securely below-the-waistband for 100% total concealment. The actual loop clip itself has been modified using grip tape that is strategically attached inside the actual loop which keeps the belt clip from shifting on the belt. The grip tape is also strategically placed on the remaining shaft of the loop clip (which secures the clip and sheath to the main holster) where it is makes contact with the below the waistband portion of the pant eliminating holster shifting once seated into position for wear. Grip tape is also used on the surface of the blade sheath for added backup stability below the pant. This unique mounting and retention design are hyper critical for sprinting, fighting, climbing, rappelling and other activities associated with high risk raids, snatch and grabs other special operations which are critical for counter terror warfare.

The holster of the present invention allows the use of a full sized or semi compact firearm to be fully concealed when used. The unique raised belt clip mounting position allows any full sized pistol to comfortably seat below the waistband with no printing. When worn appendix style carry, the longer barrel of the full sized pistol rides down the pants in between the left inner thigh and groin (for a right handed shooter) virtually disappearing into the open space between the groin and inner thigh area of all pants. This unique thigh/groin holster seating enables the larger handle of a full sized weapon to sit comfortably approximately a half inch below the waistband across the pelvis area very easily. Additionally, the long barrel increases easiness of the pocket assist draw since the barrel is closer to the hand while inserted inside the pocket increasing overall rapid draw speed while increasing overall accuracy since it is a full sized firearm that is being presented against the target.

The holster of the present invention is fully adjustable for left and right handed shooters. The holster can be pre set at the factory or a user may adjust the holster for his fitting. The below the waistband design of the holster allows for several unique rapid draw techniques to be used that include: 1) thumb assisted draw, which allows the weak hand to be quickly inserted behind the pant at the buckle area and tugs the pant slightly forward allowing the shooting hand to dip below the waistband and firmly grab and present the weapon quickly to fire; 2) pocket assist draw, which allows the weak hand to be inserted into the weak side pocket and the weak hand presses up on the barrel while in the pocket in an upwards motion forcing the barrel upwards causing the handle of the firearm to clear the waistline rapidly allowing the firearm to quickly be drawn and presented at the target.

The holster of the present invention provides additional advantages: 1) single clip mount for rapid attach and detach and this means that it can be put on and taken off quickly; 2) the weapon is ideal for overweight users because when worn below the waistband it does not cut into your stomach region; 3) the size of the holster and its positioning due to its unique design allows the users to urinate without having to remove the holster.

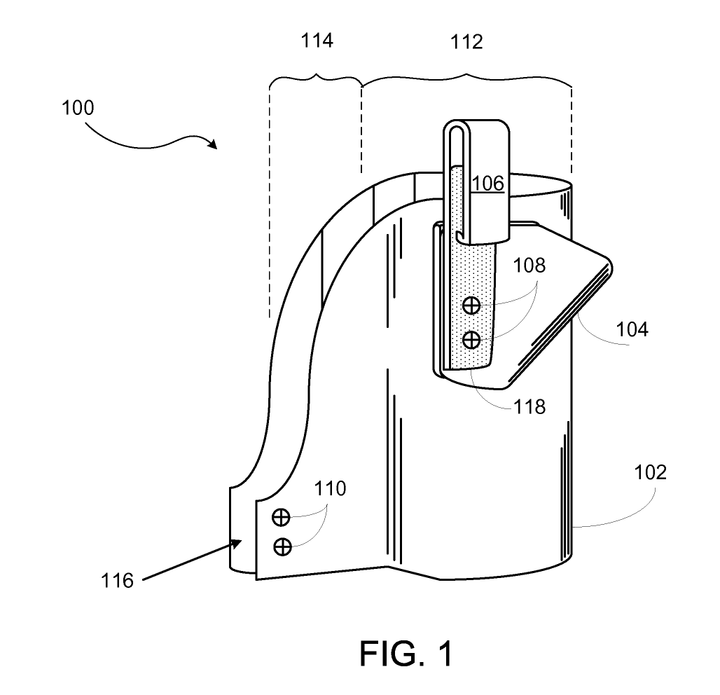

Advantages of the present invention are easily understood through the following description and the related drawings. FIG. 1 illustrates a holster 100 molded from one single piece of hard plastic 102, preferably thermoplasticacylic-polyvinyl chloride material, with a high cut retention section 112 and an enclosed trigger guard section 114. The holster 100 is molded from a single hard plastic that wraps around and defines a space for holding a hand gun. The holster 100 has an opening 116 that is secured through screws 110 and a blade sheath 104 secured on the side of the holster 100 by a belt clip 106 and few screws 108. The sheath 104 is also molded from one single piece of hard plastic, preferably the same thermoplasticacylic-polyvinyl chloride material. Both the sheath 104 and the holster 100 may be covered externally by fabric or other soft material for better feely-touchy feeling when in contact with human skin. The sheath is for holding a blade and disposed angularly away from the belt clip 106, preferably 35 degrees clockwise relative to the belt clip 106. The blade is inserted in 35 degrees from the belt clip 106. A friction layer 118 can be placed on the belt clip 106 to increase the friction with the belt and to reduce the movement of the belt relative to the belt clip 106. The friction layer 118 may be a sand-paper-like material.

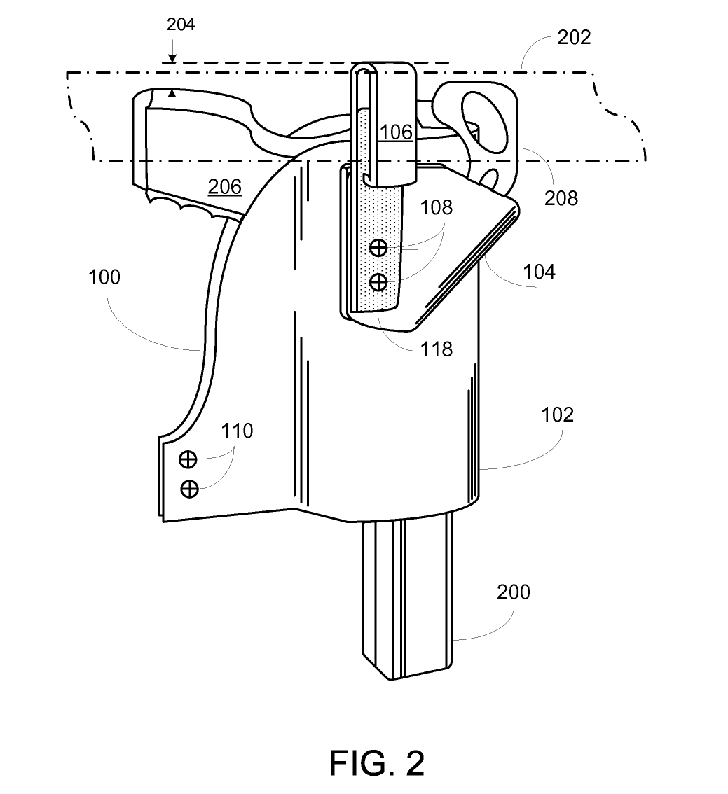

FIG. 2 illustrates a hand gun 200 inserted in the holster 100. Broken lines represent a belt 202. When the holster 100 is clipped onto the belt 202, the high cut retention section 112 allows the hand gun 200 to sit deep into the holster 100 with the hammer of the firing mechanism of the hand gun practically at the same or beneath the level of the top edge of the high cut retention section and provides extreme retention capability that prevents the hand gun 200 from slipping out even when the user is inverted. When the hand gun 200 is inserted into the holster 100, the trigger mechanism of the hand gun 200 is fully encapsulated the trigger guard section 114, thus preventing any accidental firing of the hand gun 200. The distance 204 represents the distance between the top edge of the handle 206, when the hand gun 200 is inserted into the holster, and the top edge of the belt clip 106. Because of the special design of the present invention, the distance 204 ensures that the hand gun 200 is not visible when the holster is placed inside the pants. When a blade 208 is placed into the sheath 104, the handle of the blade sits approximately at the same level of the hammer of the hand gun 200.

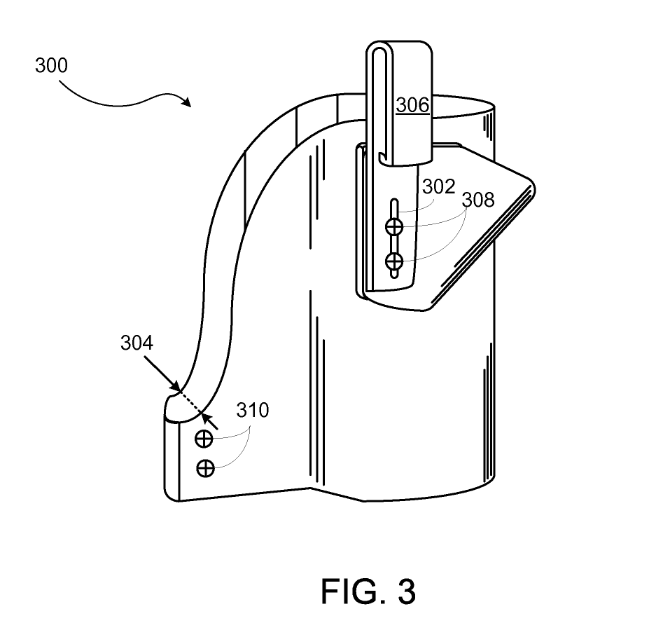

FIG. 3 illustrates a holster 300 according to one alternative embodiment of the present invention. The holster 300 is formed by a single piece of a hard plastic and molded to define a space for holding a hand gun. The single piece of the hard plastic has a shape similar to a tube and without any opening, such as opening 116 in FIG. 1. The retention force provided by the holster 300 can be adjusted by one or more screw 302. By tightening the screw 310, the space 304 between two sides is reduced, thus increasing the retention force on the hand gun 200 when it is inserted into the holster 300. This retention force adjustment mechanism can also be used for the embodiment shown in FIG.

The belt clip 306 has a slot 302 through which screws 308 can be inserted. When the screws 308 are loosen, the position of the belt clip 306 can be adjusted. By adjusting the position of the belt clip 306, the position of a hand gun 200 inside the holster 300 relative to the belt clip 306 can be adjusted. This adjustment allows the user to use the holster 300 with different sizes of hand guns 200.

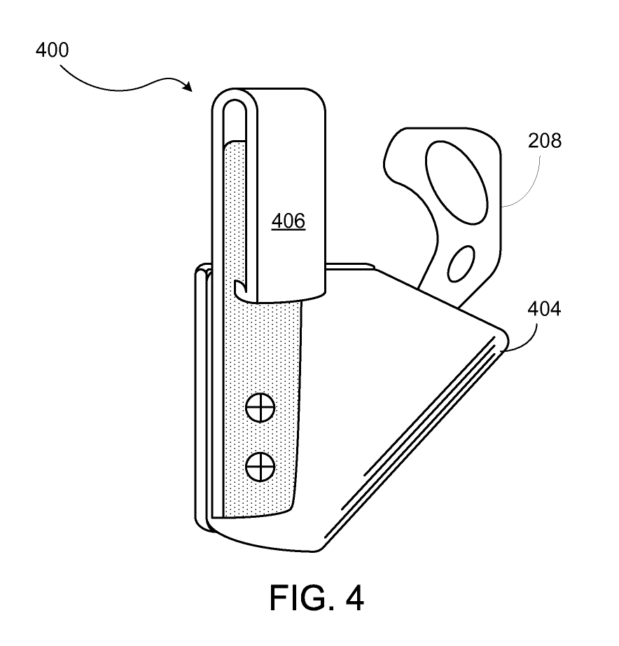

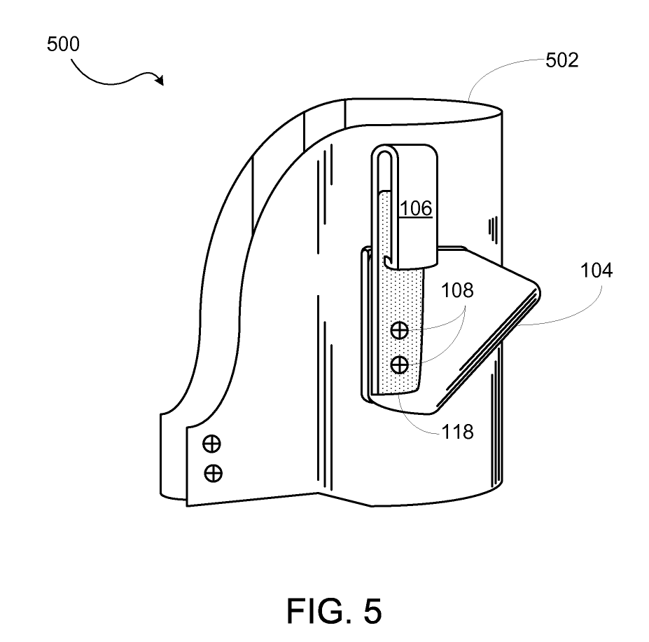

FIG. 4 illustrates a blade holder 400 according to one alternative embodiment of the present invention. The blade sheath 400 has a sheath 404 made from a hard plastic material described above attached to a belt clip 406 where a blade 208 can be inserted. FIG. 5 illustrates a holster 500 according to yet another alternative embodiment of the present invention. The holster 500 has a belt clip 106 and a blade sheath 104 attached toward lower part of the holster 500, such that the top of the belt clip 106 is lower than the top edge 502 of the holster 500. The configuration of the holster 500 allows the holster 500 to be placed on the outside of the pants, thus allowing the hand gun to be visible and enabling a quick draw. Though figures show the belt clips placed on one side of the holsters, it is understood that the belt clip can be placed on either side of the holster.

The holster according to the present invention provides safety to an undercover law enforcement officer or a special operation agent. The holster allows the hand gun to be hidden from plain view and also tightly secures the hand gun in place even when the officer is held upside down or in a physical fight. Because the firing mechanism of the hand gun is enclosed by a trigger guard section, the danger of accidental firing is eliminated.

Though the material for the holster is generally described as hard plastic, such as thermoplasticacylic-polyvinyl chloride material, it is understood that other suitable material, such as aluminum or other metals, may also be used. It will be apparent to a person skilled in the relevant art that features described in different embodiments described in the present specification may be combined. It is to be appreciated that the Detailed Description section, and not the Summary and Abstract sections, is intended to be used to interpret the claims. The Summary and Abstract sections may set forth one or more but not all exemplary embodiments of the present technology as contemplated by the inventor(s), and thus, are not intended to limit the present technology and the appended claims in any way.

What is claimed is:

1. A safety holster, for a hand gun with a handle and a trigger mechanism, comprising:
a retention section;
a trigger guard section in communication with the retention section;
a blade sheath secured to the retention section; and
a belt clip attached to the blade sheath.

2. The safety holster of claim 1, wherein the safety holster is formed by a single piece material and has an opening.

3. The safety holster of claim 2, wherein the opening is secured by at least one fastening device.

4. The safety holster of claim 3, wherein the opening defines a width, which can be adjusted by the at least one fastening device.

5. The safety holster of claim 1, wherein the safety holster is formed by a tube like material that defines a space for a hand gun.

6. The safety holster of claim 5, further comprising at least one fastening device attached to the holster, wherein the space for hand gun can be adjusted by the at least one fastening device.

7. The safety holster of claim 1, wherein the belt clip has a top edge and the handle of the hand gun is below the top edge of the belt clip.

8. The safety holster of claim 1, wherein the trigger guard section fully covers the trigger mechanism of the hand gun.

9. The safety holster of claim 1, further comprising a friction layer attached to the belt clip.

10. The safety holster of claim 1, wherein a slot is defined on the belt clip and at least one fastening device is inserted through the slot to attach the belt clip to the retention section, a position of the belt clip relative to the retention section is adjusted by sliding the belt clip.

11. The safety holster of claim 1, the blade sheath is placed angularly away from the belt clip.

12. The safety holster of claim 1, wherein the retention section is formed by a thermoplasticacylic-polyvinyl chloride material.

13. The safety holster of claim 1, wherein the retention section is formed by aluminum.

14. A blade holder comprising:
a sheath;
a belt clip attached to the sheath; and
a friction layer attached to the belt clip,
wherein the sheath is disposed angularly away from the belt clip.

15. The blade holder of claim 14, wherein the sheath is disposed 35 degrees away from the belt clip.

16. The safety holster of claim 14, wherein the sheath is formed by a thermoplasticacylic-polyvinyl chloride material.
